(19) United States
(12) Patent Application Publication
(10) Pub. No.: US 2010/0214721 A1
(43) Pub. Date: Aug. 26, 2010

(54) Electric double layer capacitor package

(75) Inventors: Sang Kyun Lee, Suwon (KR); Gi Rak Lee, Seoul (KR); Ho Joo Lee, Suwon (KR); Hyun Chul Jung, Yongin (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/585,154

(22) Filed: Sep. 4, 2009

(30) Foreign Application Priority Data
Feb. 23, 2009 (KR) 10-2009-0015008

(51) Int. Cl. H01G 9/08; H01G 9/155

(52) U.S. Cl. 361/502

(57) ABSTRACT

An electric double layer capacitor package includes a package body including a groove region formed by removing a portion from a surface thereof, an electric double layer capacitor disposed in the groove region of the package body, and including first and second electrodes and an ion permeable separator disposed between the first and second electrodes, and first and second conductive vias each disposed in an inner portion of the package body and each having one end connected to one of the first and second electrodes, respectively and the other end extending from the one end toward a bottom surface of the package body in the case that the surface is defined as an upper region of the package body. The electric double layer capacitor package can be surface-mounted without using an additional structure. The use of the electric double layer capacitor package achieves a reduction in thickness and mounting area, thereby contributing to the production of lighter and smaller products.

### CROSS-REFERENCE TO RELATED APPLICATIONS

This application claims the priority of Korean Patent Application No. 2009-0015008 filed on Feb. 23, 2009, in the Korean Intellectual Property Office, the disclosure of which is incorporated herein by reference.

### BACKGROUND OF THE INVENTION

1. Field of the Invention

The present invention relates to an electric double layer capacitor package, and more particularly, to an electric double layer capacitor package having a structure enabling surface mounting.

2. Description of the Related Art

In general, electric double layer capacitors are energy storage devices using a pair of charge layers (i.e., electrode layers) having opposite polarities. Electric double layer capacitors can be repeatedly charged and discharged, and are advantageous over other general capacitors in terms of their higher energy efficiency and output as well as their superior durability and reliability. For this reason, of late, electric double layer capacitors that are rechargeable with high current have been considered to be promising power storage devices, for use in situations where power storage devices are charged and discharged frequently, such as auxiliary power sources for mobile phones, electric automobiles or solar batteries.

In general, electric double layer capacitors include a separation layer, that is, a separator interposed between a pair of polarizable electrode layers having positive and negative polarities, respectively. Each of the polarizable electrode layers are impregnated with an aqueous electrolyte solution or non-aqueous electrolyte solution.

A common surface mount technology (SMT) used to surface-mount an electric double layer capacitor on a circuit board involves welding brackets on the top and bottom of a coin type electric double layer capacitor and mounting the electric double layer capacitor on a circuit board through the brackets.

However, this coin type electric double layer capacitor has a relatively large thickness, and an additional structure required for surface mounting, such as a bracket, renders the electric double layer capacitor even thicker. Accordingly, if a coin type electric double layer capacitor is used, an increase in thickness hinders the production of high-capacity products, and additional processes increase product costs.

### SUMMARY OF THE INVENTION

An aspect of the present invention provides an electric double layer capacitor package which can be surface-mounted without using an additional structure.

An aspect of the present invention is also to render products smaller and lightweight by reducing the thickness and mounting area of the electric double layer capacitor.

According to an aspect of the present invention, there is provided an electric double layer capacitor package including: a package body including a groove region formed by removing a portion from a surface thereof; an electric double layer capacitor disposed in the groove region of the package body, and including first and second electrodes, and a separator disposed between the first and second electrodes; and first and second conductive vias each disposed in an inner portion of the package body and each having one end connected to one of the first and second electrodes, respectively and the other end extending from the one end toward a bottom surface of the package body in the case that the surface is defined as an upper region of the package body.

The package body may be formed of ceramics or a metallic material.

The electric double layer capacitor package may further include first and second surface-mounting pads disposed on a bottom surface of the package body and connected to the other ends of the first and second conductive vias, respectively.

The electric double layer capacitor may further include first and second current collectors formed on the first and second electrodes, respectively. The first and the second current collectors may be bonded with the first and second conductive vias by using conductive epoxy, respectively.

The first and second current collectors and the first and second conductive vias may be formed of the same material.

The electric double layer capacitor package may further include a cover structure formed on the package body to cover the electric double layer capacitor. The electric double layer capacitor package may further include a welding material disposed between the cover and the package body.

The electric double layer capacitor may include a plurality of cells each including the first and second electrodes and the separator therebetween. The plurality of cells may be laminated upwardly from the lower portion of the package. The electric double layer capacitor package may further include an insulating material applied to an outer side of the electric double layer capacitor to prevent a short-circuit between the plurality of cells.

The first and second electrodes may each have a thickness ranging from 10 μm to 200 μm.

The electric double layer capacitor may have a greater thickness than a height of the groove region to protrude outwardly.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view depicting an electric double layer capacitor package according to an exemplary embodiment of the present invention;

FIG. 2 is a schematic cross-sectional view depicting a connection between a current collector and a conductive via according to a modification to the embodiment of FIG. 1;

FIG. 3 is a schematic cross-sectional view depicting the multilayer structure of an electric double layer capacitor according to the embodiment of FIG. 1; and

FIG. 4 is a schematic cross-sectional view depicting an electric double layer capacitor package according to another exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity. Like reference numerals in the drawings denote like elements, and thus their description will be omitted.

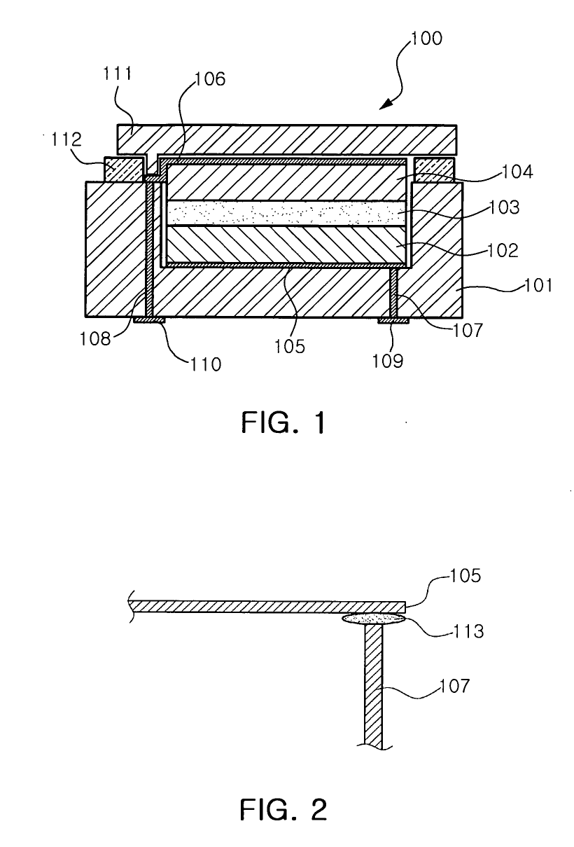

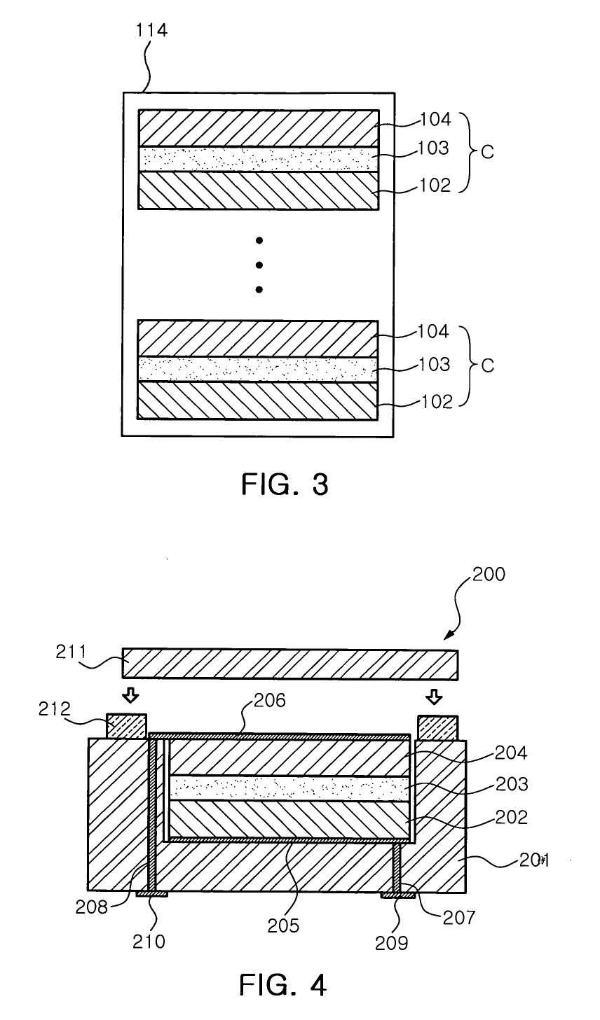

FIG. 1 is a schematic cross-sectional view depicting an electric double layer capacitor package according to an exemplary embodiment of the present invention. FIG. 2 is a schematic cross-sectional view depicting a connection between a current collector and a conductive via according to a modification to the embodiment of FIG. 1. FIG. 3 is a schematic cross-sectional view depicting the multilayer structure of an electric double layer capacitor according to the embodiment of FIG. 1.

Referring to FIG. 1, an electric double layer capacitor package 100, according to this embodiment, includes a package body 101 and an electric double layer capacitor disposed inside the package body 101. The electric double layer capacitor includes first and second electrodes 102 and 104, and a separator 103 disposed therebetween. The first and second electrodes 102 and 104, and the separator 103 constitute a single unit cell. First and second current collectors 105 and 106 may be disposed on the first and second electrodes 102 and 104, respectively.

The package body 101 includes a groove region receiving the electric double layer capacitor, and first and second conductive vias 107 and 108 used for surface mounting are formed in the inner portion of the package body 101. The electric double layer capacitor package 100 has a structure that allows for surface mounting for itself. Therefore, the internal structure of the electric double layer capacitor package 100 needs to be protected from a high temperature of about 260° C. in the process of surface mounting. In particular, a liquefied electrolyte contained in the electric double layer capacitor needs not to be leaked. To this end, the package body 101 may be formed of ceramics or a metallic material, not resin such as epoxy, and may be bonded with a cover 111 disposed on the package body 101 by the use of a welding method or the like.

The first and second electrodes 102 and 104 may utilize a polarizable electrode material, such as activated carbon having a relatively high specific surface area. Also, the first and second electrodes 102 and 104 are impregnated with an electrolyte such as an aqueous sulfuric acid solution, thus serving as charge layers. In this case, the first and second electrodes 102 and 104 may be manufactured by forming an electrode material mainly formed of activated carbon powder into solid sheets, or adhering electrode material slurry onto the first and second current collectors 105 and 106.

The separator 103 may be formed of an ion-permeable porous material. An example of the porous material may include polypropylene, polyethylene or glass fiber. Although not shown, a structure such as a gasket may be further provided in order to prevent electrolyte leakage and a short-circuit.

The first and second current collectors 105 and 106 are conductive sheets to transfer electrical signals to the first and second electrodes 102 and 104, respectively. The first and second current collectors 105 and 106 may utilize a conductive polymer, a rubber sheet or metallic foil. In this case, the shapes of the first and second current collectors 105 and 106 may be modified properly such that they are connected to the first and second conductive vias 107 and 108 respectively. Here, the first and second conductive vias 107 and 108 extend downwardly of the package body 101. In detail, as shown in FIG. 2, the second current collector 105 may be partially bent so as to connect the second electrode 102 to the second conductive via 107, and such modification to the shape may be affected by the shape or size of the electric double layer capacitor. The first and second current collectors 105 and 106 may be connected directly to the first and second conductive vias 107 and 108, respectively. Alternatively, as shown in FIG. 2, the connections may be made via conductive epoxy 113.

The first and second conductive vias 107 and 108 are formed in the inner portion of the package body 101, and are disposed in the thickness direction of the package body 101 to provide connection to an external power source. The first and second conductive vias 107 and 108 may contact the first and second current collectors 105 and 106, respectively, and may be formed of the same material as that of the first and second current collectors 105 and 106. In the event that the first and second current collectors 105 and 106 are absent, the first and second conductive vias 107 and 108 may be connected directly to the first and second electrodes 102 and 104, respectively. First and second surface-mounting pads 109 and 110 are disposed on the bottom of the package body 101, and are connected to the first and second conductive vias 107 and 108, respectively. Because of the above structure, the electric double layer capacitor package 100 may be surface-mounted on a circuit board or the like without using an additional structure such as a bracket.

According to this embodiment, the electric double layer capacitor is disposed inside the groove region of the package body 101 of ceramics or a metallic material, and is electrically connected to terminals for an outside connection, that is, the surface-mounting pads 109 and 110 by the use of the conductive vias 107 and 108. This may lead to a reduction in the thickness of the electric double layer capacitor package 100 and further in its mounting area. In detail, the first and second electrodes 102 and 104 each may have a thickness ranging from about 10 μm to 200 μm, and the thickness thereof is controllable according to the composition of a binder and the rolling conditions for the electrodes.

FIG. 1 illustrates the electric double layer capacitor having a single cell. However, as shown in FIG. 3, a plurality of cells C may be laminated upwardly from the bottom of the package body 101, thereby ensuring higher electric capacity. In this case, the plurality of cells C may be connected properly in series or parallel. An insulating material may be applied to the outer side of the laminate of the plurality of cells C in order to prevent an undesired short-circuit.

The cover 111 is disposed on the package body 101 to cover and protect the electric double layer capacitor. The package body 101 and the cover 111 may be formed of ceramics or a metallic material to provide effective protection to the electric double layer capacitor. The package body 101 and the cover 111 may be bonded together by use of a welding material 112. In this case, as shown in FIG. 1, the electric double layer capacitor is spaced apart from the cover 111. However, the cover 111 may be pressed onto the package body 111 to seal the electric double layer capacitor.

FIG. 4 is a schematic cross-sectional depicting an electric double layer capacitor package according to another exemplary embodiment of the present invention. As in the embodiment of FIG. 1, an electric double layer capacitor package 200, according to this embodiment, includes a package body 201, an electric double layer capacitor, first and second conductive vias 207 and 208, and first and second surface-mounting pads 209 and 210. Here, the electric double layer capacitor includes first and second electrodes 202 and 204, a separator 203 disposed between the first and second electrodes 202 and 204, and first and second current collectors 205 and 206. Also, in the electric double layer capacitor package 200, the package body 201 and the cover 211 are bonded together by the use of a welding material 212. According to this embodiment, as shown in FIG. 4, the height of the groove region of the package body 201 is equal to the thickness of the electric double layer capacitor, whereas in the embodiment of FIG. 1, the electric double layer capacitor protrudes outside due to its thickness which is greater than the height of the groove region of the package body 101.

As set forth above, according to exemplary embodiments of the invention, the electric double layer capacitor package itself can be surface-mounted without using an additional structure. Moreover, the use of the electric double layer capacitor package according to the embodiments of the present invention ensures a reduction in thickness and mounting area, thereby contributing to manufacturing lightweight and smaller products.

While the present invention has been shown and described in connection with the exemplary embodiments, it will be apparent to those skilled in the art that modifications and variations can be made without departing from the spirit and scope of the invention as defined by the appended claims.

What is claimed is:

1. An electric double layer capacitor package comprising:
a package body including a groove region formed by removing a portion from a surface thereof;
an electric double layer capacitor disposed in the groove region of the package body, and comprising first and second electrodes, and an ion permeable separator disposed between the first and second electrodes; and
first and second conductive vias each disposed in an inner portion of the package body and each having one end connected to one of the first and second electrodes, respectively and the other end extending from the one end toward a bottom surface of the package body in the case that the surface is defined as an upper region of the package body.

2. The electric double layer capacitor package of claim 1, wherein the package body is formed of ceramics or a metallic material.

3. The electric double layer capacitor package of claim 1, further comprising first and second surface-mounting pads disposed on a bottom surface of the package body and connected to the other ends of the first and second conductive vias, respectively.

4. The electric double layer capacitor package of claim 1, wherein the electric double layer capacitor further comprises first and second current collectors formed on the first and second electrodes, respectively.

5. The electric double layer capacitor package of claim 4, wherein the first and the second current collectors are bonded with the first and second conductive vias by using conductive epoxy, respectively.

6. The electric double layer capacitor package of claim 1, wherein the first and second current collectors and the first and second conductive vias are formed of the same material.

7. The electric double layer capacitor package of claim 1, further comprising a cover structure formed on the package body to cover the electric double layer capacitor.

8. The electric double layer capacitor package of claim 7, further comprising a welding material disposed between the cover and the package body.

9. The electric double layer capacitor package of claim 1, wherein the electric double layer capacitor comprises a plurality of cells each comprising the first and second electrodes and the separator therebetween, and
the plurality of cells are laminated upwardly from the lower portion of the package.

10. The electric double layer capacitor package of claim 9, further comprising an insulating material applied to an outer side of the electric double layer capacitor to prevent a short-circuit between the plurality of cells.

11. The electric double layer capacitor package of claim 1, wherein the first and second electrodes each have a thickness ranging from 10 μm to 200 μm.

12. The electric double layer capacitor package of claim 1, wherein the electric double layer capacitor has a greater thickness than a height of the groove region to protrude outwardly.
